(19) United States
(12) Patent Application Publication
(10) Pub. No.: US 2001/0040960 A1
(43) Pub. Date: Nov. 15, 2001

(54) Method, system and device for using a regular telephone as a computer audio input/output device

(76) Inventors: Eitan Hamami, Rosh Haayin (IL); Efrat Ramati, Tel Aviv (IL)

Correspondence Address: DR. MARK FRIEDMAN LTD., c/o ANTHONY CASTORINA, SUITE 207, 2001 JEFFERSON DAVIS HIGHWAY, ARLINGTON, VA, 22202, US

(21) Appl. No.: 09/843,921

(22) Filed: Apr. 30, 2001

Related U.S. Application Data
(60) Provisional application No. 60/200,882, filed on May 1, 2000.

(51) Int. Cl. H04M 1/00; H04M 3/00

(52) U.S. Cl. 379/352; 379/355.03

(57) ABSTRACT

A method, system and device for audio input/output to a computer using a regular telephone. Analog data transfer between the telephone and the computer is facilitated by an adapter that does not perform A/D conversion. The adapter is switchable between operating states and modes.

### This application claims priority from US Provisional Application No. 60/200,882 filed May 1, 2000.

### FIELD AND BACKGROUND OF THE INVENTION

The present invention relates to a method, system and device for using a regular telephone as an input/output peripheral device to a computer such as a PC, in addition to its regular telephony functions. Specifically, a regular telephone can be connected through an adapter that does not convert analog to digital (A/D) or D to A signals, directly to the analog input/output ports of a computer, more specifically replacing the microphone and speakers normally connected to the computer. Various configurations of telephones connected to computers for purposes of Internet, Intranet or data network telephony are known, as described for example in U.S. Pat. No. 5,838,665 to Kahn, or in WIPO Application No. WO9839897A1 by Shahar. However, these configurations normally require either special telephones, as in Kahn's patent, or A/D adapters and other peripheral connection or conversion elements, all of which add to the cost and cumbersomeness of the combined telephone-computer system.

Voice-over IP clients that are implements in software, for example VocalTec Internet Phone or MS NetMeeting, use the computer audio peripherals in order to input voice into the software phone, and output voice to the user. The user usually employs a standard microphone and speakers that are attached to the computer. These computer audio peripherals have several problems, such as low audio quality and lack of privacy, the microphone and the speakers, echo is added to the voice stream, further reducing the audio quality; and privacy—telephone users are used to talk in relative privacy over the phone handset. The microphone and speakers do not supply this privacy. The prior solutions suggested in this regard are either expensive or of inferior quality, or both. Thus, typical solutions such as headsets or headsets+microphone assemblies tend to be expensive, lower quality ones normally costing over $20, with better quality coming at an increasing price.

There is thus a recognized need for, and it would be highly advantageous to have, a method and system that uses regular telephones as audio input/output devices for computers in addition to their regular functions, without the need of intermediate A/D converters. There is also a recognized need for a simple, high quality, inexpensive method and system for inputting/outputting audio data to a computer. Moreover, there is a recognized need for having a simple, high quality and inexpensive device that allows such input/output to be carried out.

### SUMMARY OF THE INVENTION

According to the present invention there is provided a method for inputting/outputting audio data to or from a computer via at least one regular telephone. the method comprising: a) electrically connecting a configurable adapter between the at least one telephone and the computer; and b) facilitating analog data transfer through the adapter between the at least one telephone and the computer.

According to the present invention there is provided a system for audio data input/output to a computer, comprising: a) at least one telephone, and b) a configurable adapter connected between and in analog communication with, the at least one telephone and the computer.

According to the present invention there is provided an adapter that facilitates data communication between at least one regular telephone and a computer, while allowing various connections to audio peripherals, comprising: a) electrical connection means to the at least one telephone and the computer, and b) switching means to change operation modes by which the data communication is carried out.

The present invention successfully addresses the shortcomings of the presently known configurations by providing a high quality, low cost computer audio input/output method and system, through the use of a regular telephone, and without A/D conversion between the telephone and the computer.

### BRIEF DESCRIPTION OF THE DRAWINGS

The invention is herein described, by way of example only, with reference to the accompanying drawings, wherein:

FIG. 1 is a schematic diagram of a basic embodiment of the system of the present invention.

FIG. 2 is a schematic diagram of a basic embodiment of a basic embodiment of the adapter of the present invention.

FIG. 3 is a schematic diagram of an embodiment of the system in which commands are transferred between telephone and computer vie audio cables.

FIG. 4 is a schematic diagram of an embodiment of the system in which commands are transferred between telephone and computer via another digital port of the computer.

FIG. 5 is a schematic diagram showing the connection of the PSTN line also to the computer as an in/out device.

### DESCRIPTION OF THE PREFERRED EMBODIMENTS

The present invention relates to a method and system for using a telephone as an input/output peripheral device to a computer, in addition to its regular telephony functions. Preferably, the telephone is a regular telephone. Specifically, the invention describes a “non analog to digital (A/D)” configurable adapter, which connects directly a regular telephone to the analog input/output ports of a computer, the telephone thus replacing the microphone and speakers normally connected to the computer. The “non A/D” adapter thus enables the use of a regular telephone as an audio computer device connected directly to the sound card of the computer, replacing the common speakers and microphone. The disclosure will refer hereafter mainly to this adapter, its function, its connection modes and states, etc. under the generic name of “PhoneConnect”. A regular telephone connected through the PhoneConnect adapter to a computer can, for example: 1) place or receive Internet calls; 2) send and receive voice messages such as VoiceMail; 3) have its keypads used to send DTMF signals to the computer; 4) perform voice communication with the computer; and 5) ring upon a command from the computer(e.g. Wakeup service). The adapter can be also connected to the telephone line, thus connection the telephone and/or the computer to the line. Optimally, the speakers and the microphone can be connected to the adapter, and activated whenever required by the user, through a mechanical switch on the adapter.

The present invention provides a low cost, high quality solution to the computer audio problem listed above. Among other attributes, the PhoneConnect adapter and related architecture improve the audio quality by reducing feedback from the system,; allow the use of a plurality of phones as peripheral input/output device to a computer; and allow remote phones to act as input/output devices to a computer. PhoneConnect further improves the user experience by automatically determining if the audio signal should be routed to the computer audio peripherals or the telephone.

The principles and operation of a PhoneConnect adapter according to the present invention may be better understood with reference to the drawings and the accompanying description.

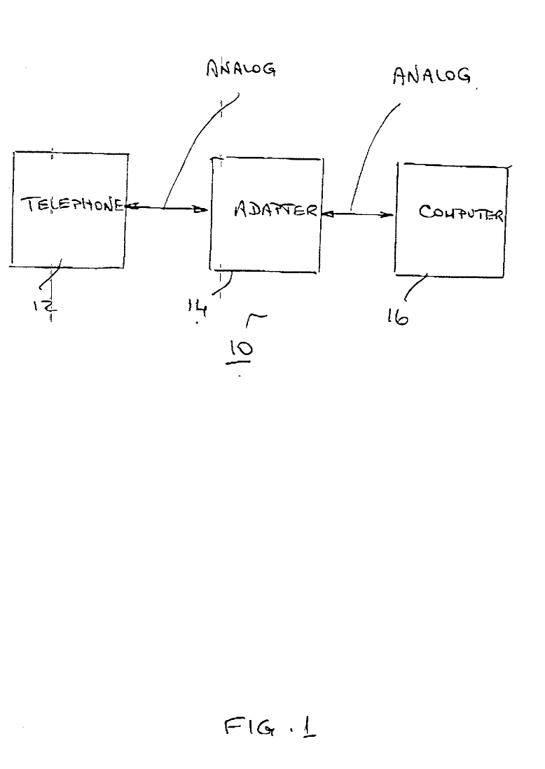

Referring now to the drawings, FIG. 1 illustrates a basic embodiment of a system 10 that includes one or more telephones 12 electrically connected (in “data communication”) through a PhoneConnect configurable adapter 14 to a computer 16. Preferably, telephone 12 is a regular (wired or wireless) telephone of the type used with PSTN lines. Adapter 14 can be a separate (stand-alone) unit, as shown in FIG. 1, or it can be implemented in a modem or audio card of a computer 16. Adapter 14 is using analog signals with both telephone 12 and computer 16, and can be configured to operate in different operating modes, for different purposes, as explained in detail below.

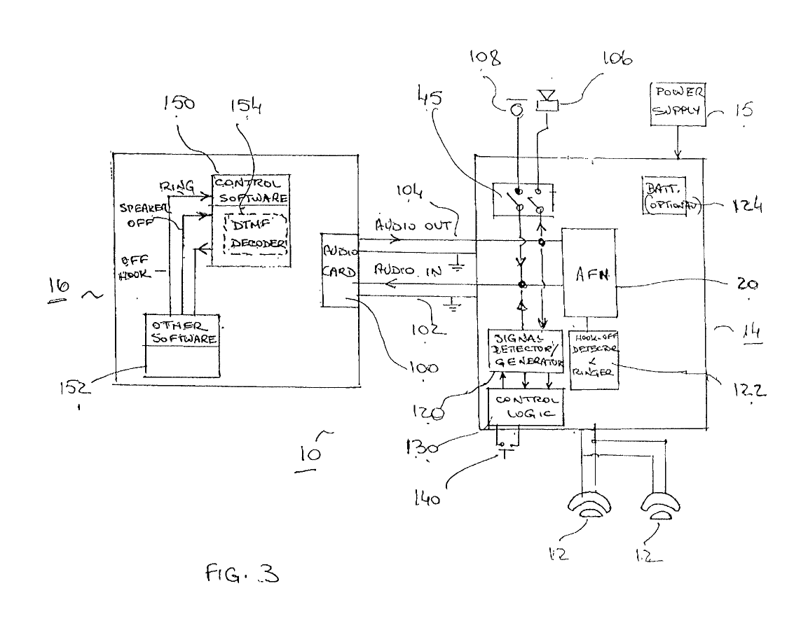

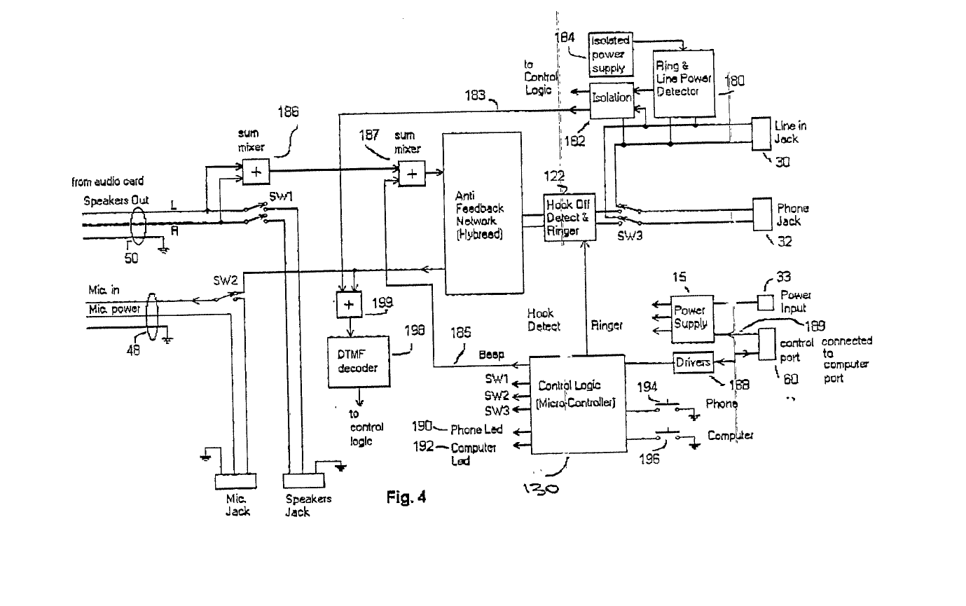

In the basic mode, there is analog signal transfer between telephone 12 and computer 16, facilitated by adapter 14. This entirety analog transfer is essentially different from that provided by the system of Shahar in WO9839897A1, as exemplified by his FIG. 1, where the adapter-telephone connection is analog, but the adapter-computer connection is digital. Adapter 14 is preferably powered by a power supply 15 that gets its power from internal battery 124 (see FIG. 3) from an external power input 33 (see FIG. 4), from computer 16 through one of its ports 189 (see FIG. 4), or from the PSTN line.

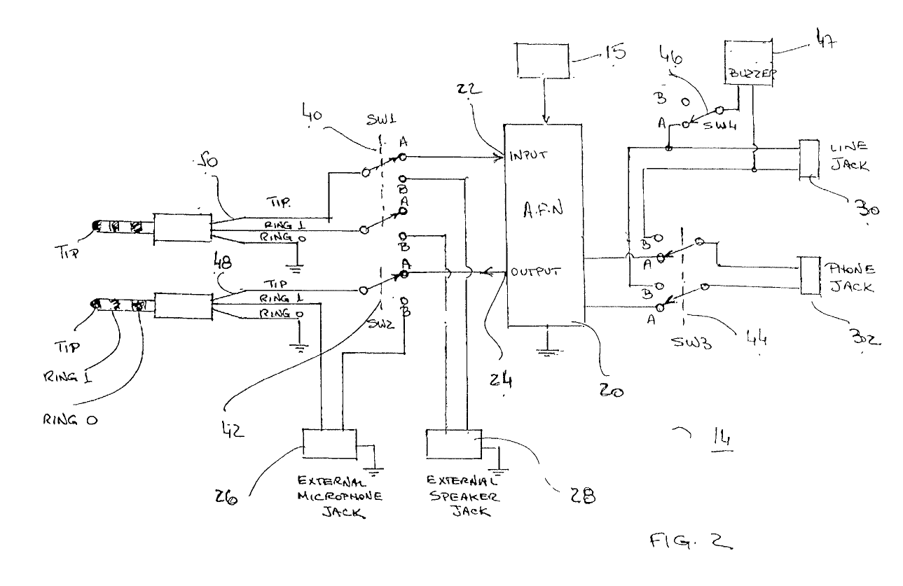

FIG. 2 shows a preferred embodiment of adapter 14 that enables the system to operate in and switch between the different operation modes. Adapter 14 includes an Anti Feedback Network (AFN) 20 (sometimes called “Hybrid”) having and AFN input 22 and an AFN output 24. The AFN is a well-known element in telephony systems. In the present invention, is fulfills (among others) the role of detector of ON/OFF-HOOK states of the telephone. For example, when the telephone is in ON-HOOK, it impedance does not generally match that of the AFN, and the AFN will not prevent feedback, thus allowing the detection of this state by sensing the signal level at an adapter output 48 while applying signal to an adapter input 50.

Typically, the adapter is electrically connected by various connecting means to the computer peripherals (external microphone and speakers) via an external microphone jack 26 and an external speaker jack 28, to the PSTN line through a line jack 30, and to the telephone through a phone jack 32. The connections can be made through two-state switches SW, marked SW1 (40), SW2 (42), SW3 (44) and SW4 (46). In the following, all switches in this specification are included under the definition of “switching means”. As well-known to one versed in the art, electrical and semiconductor, all of which may be used for the purpose of the present invention. All switches have preferably two states, ‘A’ and ‘B’, In “state A”, the adapter enables the use of the telephone as an input/output device to the computer and uses a buzzer 47 to indicate an incoming call at the PSTN line, while disabling the external speakers and microphone. In “state B”, the adapter enables the use of the telephone as a regular telephone, and enables the use of the external speakers and microphone with the computer.

The following illustrates, in a manner of example only, the operation of the system in states A and B. In state A, AFN output 24 is connected to adapter output 48 (which includes lines “tip”, “ring 0”, and ring 1”) via switch SW2 42. AFN input 22 is connected to an adapter input 50. The AFN performs two main tasks: a) it supplies working power to the telephone; and b) it directs electrical signals from its input 22 to the telephone, but attenuates these signals at output 24, while allowing signals from the telephone to pass to output 24. The external speakers are disconnected by switch 40.

In state B, the telephone is connected to the PSTN line via switch SW3 44. In this state, switches SW1 40 and SW2 42 connect speakers 28 and microphone 26 to the computer. The microphone power (“ring 1” of 48) from the audio card is connected directly to the microphone jack 26, to supply power to the external microphone.

Transfer of information and control commands between the computer and the adapter can extend the functionality of the adapter. This transfer can be implemented in a number of ways (hereafter referred to as employing the “data communication” methods). Examples of such information and control commands from the adapter to the computer include telephone OFF-HOOK state, caller ID. incoming call from PSTN line input, or DTMF data. Examples of such command from the computer to the adapter include Mode control, Ring command or speaker Mute. The data communication between the computer and the adapter can be carried out in a number of ways. In the embodiment of FIG. 3, it is carried out via cables 102, 104 connected to the audio input/output of the audio (sound) card.

Referring now ti FIG. 3, the figure shows a schematic diagram of a more detailed embodiment of the system of the present invention. The connect between the adapter and the computer is typically done through a sound (audio) card 100 in computer 16 via cables 102 and 104. Cable 102 represents the “audio in” and is connected to the audio input of card 100. Cable 104 represents the “audio out” and is connected to the audio output of card 100. In the embodiment of FIG. 3, adapter 14 is, as in FIG. 1, a separate (stand-alone) unit. However, adapter 14 may be implemented in a modem in computer 16, or implemented as part of card 100. FIG. 3 shows adapter 14 connected electrically to one or more external speakers 106, and to an external microphone 108 (matching the connections to jacks 28, 26 respectively in FIG. 2). Card 100, being electrically connected to adapter 14, can also be connected and disconnected from peripheral components 106, 108, as discussed below. In this embodiment, adapter 14 includes a manual switch 140 used to set operation modes. Adapter 14 typically includes a signal generator/detector 120, and optionally, a Hook-Off detector and ringer 122, and an internal power source (e.g. battery) 124. In addition, the adapter may include a control logic module 130. Signal generator/detector 120 is preferably programmed to generated a predefined audio signal for each input from control logic 130, and to achieve a certain output to the control logic. of the adapter upon detecting predefined audio signals. The audio signals can be for example A, B, C, D tones of the DTMF standard, in which case the signal generator/detector will be a DTMF transceiver, or signals of any other predefined standard.

FIG. 3 also shows a computer 16, a control software 150, which serves as a driver or a service program for the adapter, and other (user application) software 152. Control software 150 may implement a DTMF decoder 154, which receives its input from audio card 100. Alternatively, a DTMF decoder 198 (FIG. 4) may be implemented in adapter 14. Control software 150 can implement a signal generator/detector in software with the predefined audio signals of the adapter. The purpose of this implementation is to detect and control the modes of operation of the PhoneConnect adapter, and to supply this ability (or service) to control software 152, as explained in more detail below. User application 152 is also in data communication with the audio card.

Using an OFF-HOOK event as an example, signal generator 120 generates a predefined audio signal for this event, and sends this signal to audio card 100 via audio in cable 104. The signal is digitized (A/D conversion) in card 100, and sent in converted digital from as an input to control software 150. The control software detects the predefined signal and sets a flag that can be read by user application 152. For example, when the telephone changes to OFF-HOOK, control logic 130 in adapter 14 sends a DTMF signal ‘A’ to the microphone via line 102 of the audio in of audio card 100. Control software 150 receives the digital data from the audio card, processes these data and detects the DTMF ‘A’ signal, then sends a message to user application 152 to start recording audio from the telephone.

Referring now to both FIGS. 2 and 3, in a first basic mode of operation (“mode 1”), telephone 12 is used as a regular telephone to place or receive calls, and connected electrically to a PSTN (wall) line. The external speakers and/or the microphone are in this mode connected electrically to audio card 100 of computer 16 through adapter 14.

In a second basic mode of operation (“mode 2”), telephone 12 is used as an audio input/output device to computer 16. In this mode, speakers 106 and microphone 108 are disconnected electrically from card 100.

In a third mode of operation (“mode 3”), more detailed below, telephone 12 is used as in the second mode, but external speakers 106 are connected to card 100, in order to hear the audio signals externally.

A switching or change between the basic operation modes can be effected in a number of ways: a) by the user, who changes the state of an electromechanical switch or pushbutton on adapter 14; b) by the user, who presses a special code (for example ##*) on the telephone keypad; c) automatically, when receiving a regular or Internet call; d) automatically, when detecting a power loss at the power supply of adapter 14 (adapter goes to mode 1) or when detecting a power loss at the PSTN line jack input (adapter goes to mode 2); and e) by a command from the computer.

FIG. 4 shows a schematic embodiment of the system in which commands are transferred (i.e. the data communication of commands is carried out) between telephone and computer via another digital port of the computer. The port in question may be for example RS232, MIDI, GAME, USB, LPT or Infra Red port. This embodiment includes in addition a Ring and PSTN line Power Detector 180 that can be operated by an isolated power supply 184. Power detector 180 sends its output to control logic 130 via an isolation part 182 (e.g. and opto-coupler). The isolation is needed because the PSTN line voltage level is not the same as the adapter and computer ground voltage levels. Also needed are the first sum mixer 186, which can be implemented with a resistor network of two resistors, and which combines the L & R stereo signals to a signal line for the AFN input. A control port 60, which is connected to a digital port of the computer, transfers commands between control logic 130 of the adapter and the computer. Additionally control port 60 can supply power to the adapter power supply 15 via a power line 189. Drivers 188 are appropriate voltage level translators, inserted if necessary between control logic 130 and the digital port of the computer. Upon a command from the control logic, Hook-Off detector and Ringer 122 can generate a high voltage ring signal to the telephone, so that the phone's internal ringer rings like a PSTN incoming ring. The above ring signal is transferred to the telephone via SW3 and phone jack 32. When the user picks up the phone, a Hook-Off state will be detected by Hook-Off detector and Ringer 122, which sends a Hook-Off signal to control logic 130. Hook-Off detector and Ringer 122 allows a clear path for all audio signals between the AFN and the telephone. A “Phone” pushbutton 194 and a “Computer” pushbutton 196 can change the modes of the adapter, to modes 1 and 2 respectively. A “Phone” LED 190 and a “Computer” LED 192 can indicate the appropriate mode. A DTMF decoder 198 is receiving its input from the AFN output via a second sum mixer 199, so that it can decode DTMF key press signals from the telephone while in mode 2. DTMF decoder 198 also receives input from the PSTN line via sum mixer 199 and an isolated PSTN signal line 183 through an isolation part 182. Thus, the DTMF decoder can decode DTMF key press signals from the telephone while the adapter is in mode 1. The decoded DTMF signal is sent to control logic 130, which can be implemented for example by a micro-controller. In addition, control logic 130 can send an audio signal to the telephone via a “Beep line” 185, and via a third sum mixer 187 to the AFN input (e.g. to indicate an incoming PSTN call in mode 2). Switches SW1, SW2 and SW3 are controlled by control logic 130.

Automatic Mode Change

As mentioned above, the adapter can change between modes automatically when it detects a PSTN line power loss. In a preferred embodiment, the adapter's PSTN line jack 30 can be connected to a modem telephone jack (not shown), and the modem's line jack can be connected to the PSTN line. When the modem is using the PSTN line, e.g. for Internet connection, the modem's telephone jack is usually disconnected from the PSTN line and no voltage is present. The adapter's control logic 130 can detect this power loss by power detector 180, and use it to change mode automatically from mode 1 (telephone 12 connected to the PSTN line jack) to mode 2, so that telephone 12, which is connected to the adapter's phone jack 32, is now connected to the computer for input/output. However, the external speakers are connected to the computer until the user picks up the telephone handset, and until an Off-Hook state is detected by Off-Hook detector 122. When power detector 180 detects line power, the control logic changes to the mode to mode 1. The mode change can take effect only when the user lies the handset on the telephone, and an On-Hook state is detected by detector 122 (“not Off-Hook” is On-Hook in mode 2) This ensures that if the user is still using the telephone with the computer (mode 2) when the modem stops using the PSTN line, the telephone will not be disconnected from the computer suddenly.

Indicating an Incoming PSTN Call in Mode 2

While the adapter is in mode 2, if a PSTN call arrives, power detector 180 detects the ring signal of the PSTN line and sends an indication to control logic 130. The control logic can then send a beep signal to the telephone via beep line 185. In addition, the control logic can cause phone LED 190 to blink.

Simplified Command Data Communication

The data communication may also be carried out by the adapter through the use of one or more input/output pins on one of the ports above as a one-bit digital port. In this case, the data transfer can be implemented by simpler and/or cheaper hardware.

The system of the present invention can use a “Call Waiting” indication, whether of a regular call (from the PSTN line) while the telephone is connected to the computer, of an Internet call indication while the telephone is connected to the PSTN line. That is, the “Call Waiting” indication can be used for example, to receive a PSTN call while in mode 2, or an Internet call when in mode 1. To indicate an incoming call from the PSTN line while in mode 2, as explained above, the adapter would preferably utilize power detector 180 with one of the data communication methods above. Typical actions to indicate Call Waiting may include: blinking of phone LED 190 or a computer LED 192, buzzing of a built-in buzzer, an electric signal being sent to the external speaker, and audio signal being sent to the telephone, or the ring detection signal being sent to the computer, to be viewed as a visual alarm on the computers video monitor. While receiving an Internet call with the PhoneConnect in mode 1, the adapter may typically receive a signal from the computer utilizing the “data communication” method, and respond with one or more of the above listed Call Waiting indications. If the telephone is not in use, the adapter can utilize high voltage (HV) ringer 122 to send an HV ring signal to the telephone and activate its ringer.

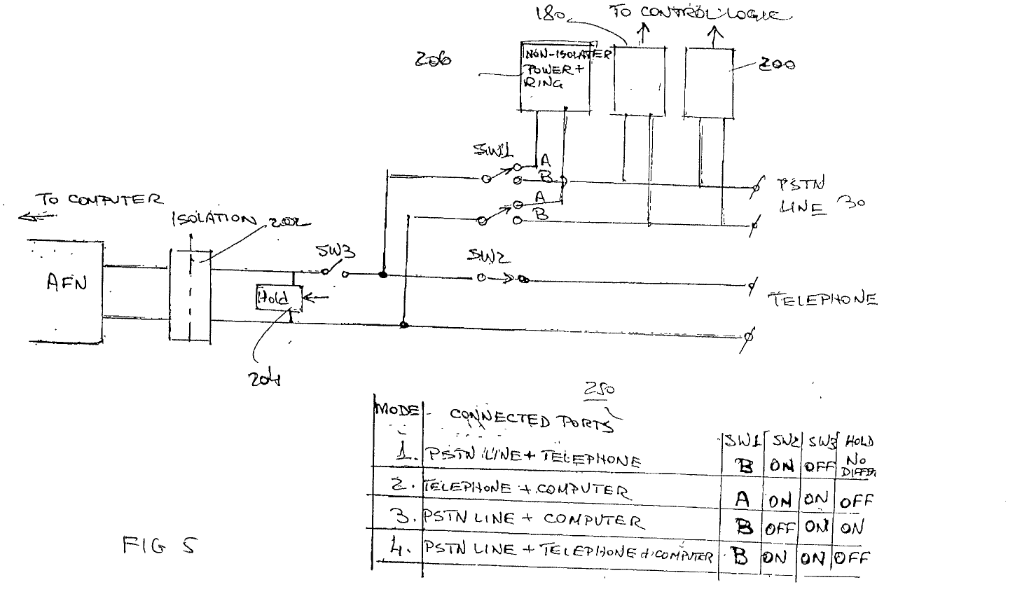

Extended Modes p FIG 5 shows possible alterations of the PhoneConnect adapter to include additional modes. In addition to modes 1 and 2 described above, this embodiment includes: mode 3—connecting the PSTN line as an input/output device to the computer, and mode 4—connecting both the PSTN line and the telephone together as an input/output device to the computer. FIG. 5 shows only the necessary parts needed to explain this embodiment. Also shown in FIG. 5 is a table of switch settings 250 for each mode. An isolation 202 is used to isolate the PSTN line in modes 1, 2 and 4 from the computer side voltages (AFN). Isolation 202 is connected to a Hold circuit 204 that provides a de hold current and impedance match for the PSTN line. The Hold circuit and switches are activated by the control logic. The Hold circuit is connected to SW3 that can disconnect Isolation 202 and Hold circuit 204 from PSTN line 30 in mod 1. SW2 is connected between the telephone and SW3, and it can be used to disconnect the telephone in mode 3. SW1 is connected between SW3 and PSTN line 30, and it can be used to disconnect the PSTN line in mode 2. In addition, in mode 2, SW1 is connecting a Non-Isolated Power+Ring (generator 206. SW1 enables the use of a non-isolated power to the telephone because it disconnects at the same time PSTN line 30 from the telephone. Detector 180 and Caller I.D circuit 200 send their output to the control logic via isolation part 182 (see FIG. 4). The DTMF signals of the telephone and from the PSTN line can be detected in the appropriate modes by DTMF decoder 198 receiving its input from the output 24 of the AFN 20 (see FIG.4).

The embodiment described in FIG. 5 is preferably implemented in a modem in the computer. Other embodiments relate to the implementation of the adapter as part of the audio card. For example, part or all of the adapter components can be added to the audio card or modem. If all the necessary adapter functions are added to the audio card, there is of course no need for a separate, stand-alone adapter. However, a stand-alone adapter may still be preferable in terms of versatility and cost-effectiveness.

Additional and optional features may be added to the Phone Connect adapter. These include:

a. DTMF control via the PC, to switch between the microphone and the speakers. This option allows the user to bypass the manual selection of the phone/audio peripherals (microphone and speakers) as described in the mode switching operations above.

b. Keyboard control. The phone keyboard can be used to transmit the DTMF signals that control the adapter operation mode, i.e. the toggle between the telephone and the audio peripherals.

c. A ringer that will ring via the phone once a voice-over IP call arrives to the computer.

d. A buzzer inside the adapter (e.g. buzzer 47 in FIG. 2).

e. Software DTMF detection and analysis components added to the computer, each DTMF sequence activating a different function through the software.

Although the invention has been described in conjunction with specific embodiments thereof, it is evident that many alternatives, modifications and variations will be apparent to those skilled in the art. Accordingly, it is intended to embrace all such alterations, modifications and variations that fall within the spirit and broad scope of the appended claims.

What is claimed is:

1. A method for inputting/outputting audio data to or from a computer via at least one regular telephone, the method comprising:
a electrically connecting a configurable adapter between the at lease one telephone and the computer, and
b. facilitating analog data transfer through said adapter between the at least one telephone and the computer.

2. The method of claim 1, wherein said adapter is a stand-alone adapter.

3. The method of claim 1, wherein said adapter is implemented in the computer modem.

4. The method of claim 1, wherein said adapter is implemented in the computer Audio card.

5. The method of claim 1, wherein said facilitating includes placing and receiving of regular calls.

6. The method of claim 1, wherein said facilitating includes sending and receiving voice messages.

7. The method of claim 1, wherein said facilitating includes using the keypad of the at least one telephone to send DTMF signals to the computer.

8. The method of claim 1, wherein said analog transfer includes voice communication.

9. A system for audio data input/output to a computer, comprising:
a. at least one telephone, and
b. a configurable adapter connected between, and in analog communication with said at least one telephone and the computer.

10. The system of claim 9, wherein said at least one telephone is regular telephone.

11. The system of claim 9, wherein said adapter is a stand-alone adapter.

12. The system of claim 9, wherein said adapter is implemented in the computer modem.

13. The system of claim 9, wherein said adapter is implemented in the computer Audio card.

14. An adapter that facilitates data communication between at least one regular telephone and a computer while allowing various connections to audio peripherals, comprising:
a. electrical connection means to the at least one telephone and the computer, and
b. switching means to change operation modes by which the data communication is carried out.

15. The adapter of claim 14, further comprising electrical connection means to audio computer peripherals and to a PSTN line.

16. The adapter of claim 15, wherein said switching means are manual.

17. The adapter of claim 15, wherein said switching means are automatic.

18. The adapter of claim 15 implemented as a stand-alone unit.

19. The adapter of claim 15, implemented in the computer modem.

20. The adapter of claim 15, implemented in the computer audio card.
